(19) United States
(12) Patent Application Publication
(10) Pub. No.: US 2016/0306858 A1
(43) Pub. Date: Oct. 20, 2016

(54) Automatic Content Sequence Generation

(71) Applicant: Altair Engineering, Inc., Troy, MI (US)

(72) Inventor: James R. Scapa, West Bloomfield, MI (US)

(21) Appl. No.: 15/131,285

(22) Filed: Apr. 18, 2016

Related U.S. Application Data
(60) Provisional application No. 62/148,960, filed on Apr. 17, 2015.

(51) Int. Cl. G06F 17/30

(52) U.S. Cl. CPC G06F 17/30528; G06F 17/30867

(57) ABSTRACT

Automatic content sequence generation may include receiving a request to access a sequence of content, identifying a primary metric and a secondary metric associated with the sequence of content, automatically identifying a second plurality of content objects from a first plurality of content objects, such that each of the second plurality of content objects has a determined similarity with the primary metric above a minimum similarity threshold, automatically identifying a third plurality of content objects from the second plurality of content objects, such that a percentage of the third plurality of content objects for which the determined similarity is above an authorship threshold corresponds with the primary metric, automatically identifying the sequence of content based on the third plurality of content objects, automatically identifying a sequentially first content object from the sequence of content, and outputting the sequentially first content object for presentation to a user.

### CROSS-REFERENCE TO RELATED APPLICATIONS

This Application claims priority to U.S. Provisional Patent Application Ser. No. 62/148,960, filed Apr. 17, 2015, which is incorporated herein by reference in its entirety.

### TECHNICAL FIELD

The present disclosure relates to systems and methods of accessing digital content.

### BACKGROUND OF THE DISCLOSURE

Digital content such as computer software products, video games, music, and any other media capable of being embodied in digital format may be sold or licensed to an end user customer. For example, the right to copy, access, or execute the digital content may be licensed to a user and a provider or vendor may retain ownership of the rights to the content. Accordingly, it may be desirable to provide automatic content sequence generation, which may include automatic content sequence generation under unit-based licensing.

### SUMMARY OF THE DISCLOSURE

Disclosed herein are aspects, features, elements, implementations, and embodiments of automatic content sequence generation.

In an embodiment, a method of accessing content using automatic content sequence generation is disclosed. Accessing content using automatic content sequence generation may include receiving input indicating a request to access a sequence of content, identifying a primary metric associated with the sequence of content, and identifying a secondary metric associated with the sequence of content. Accessing content using automatic content sequence generation may include automatically identifying a first plurality of content objects, automatically identifying a second plurality of content objects from the first plurality of content objects, such that each content object from the second plurality of content objects has a determined similarity with the primary metric above a minimum similarity threshold, and automatically identifying, by a processor in response to instructions stored on a non-transient computer readable medium, a third plurality of content objects from the second plurality of content objects. Automatically identifying the third plurality of content objects may include, on a condition that the secondary metric indicates a percentage associated with the primary metric, automatically identifying the third plurality of content objects such that a percentage of content objects included in the third plurality of content objects for which the determined similarity is above an authorship threshold corresponds with the percentage associated with the primary metric, and a percentage of content objects included in the third plurality of content objects for which the determined similarity is within the authorship threshold corresponds with a difference between 100 percent and the percentage associated with the primary metric. Accessing content using automatic content sequence generation may include automatically identifying the sequence of content based on the third plurality of content objects, automatically identifying a sequentially first content object from the sequence of content, and outputting the sequentially first content object for presentation to a user.

In another embodiment, a method of accessing content using automatic content sequence generation is disclosed. Accessing content using automatic content sequence generation may include receiving input indicating a request to access a sequence of content, identifying a primary metric associated with the sequence of content, and identifying secondary metrics associated with the sequence of content, wherein the secondary metrics include an authorship metric and a popularity metric. Accessing content using automatic content sequence generation may include automatically identifying a plurality of similar content objects from a plurality of available content objects, such that each content object from the plurality of similar content objects has a determined similarity with the primary metric above a minimum similarity threshold, and automatically identifying, by a processor in response to instructions stored on a non-transient computer readable medium, a plurality of filtered content objects from the plurality of similar content objects. Automatically identifying the plurality of filtered content objects may include automatically identifying the plurality of filtered content objects such that a percentage of content objects included in the plurality of filtered content objects for which the determined similarity is above an authorship threshold corresponds with a percentage indicated by the authorship metric, and a percentage of content objects included in the plurality of filtered content objects for which the determined similarity is within the authorship threshold corresponds with a difference between 100 percent and the percentage indicated by the authorship metric, and omitting content objects having a determined popularity that is less than a minimal popularity from the plurality of filtered content objects, wherein popularity metric indicates the minimal popularity. Accessing content using automatic content sequence generation may include automatically identifying the sequence of content based on the plurality of filtered content objects, automatically identifying a sequentially first content object from the sequence of content, and outputting the sequentially first content object for presentation to a user.

In another embodiment, a method of accessing content using automatic content sequence generation is disclosed. Accessing content using automatic content sequence generation may include receiving input indicating a request to access a sequence of content, wherein the sequence of content is associated with a primary author and an authorship metric, automatically identifying, by a processor in response to instructions stored on a non-transient computer readable medium, similar content, such that a similarity between the similar content and the primary author is above a minimum similarity threshold, and such that a percentage of the similar content for which the similarity is above an authorship threshold corresponds with a percentage indicated by the authorship metric, automatically identifying the sequence of content based on the plurality of filtered content objects, and outputting sequentially first content from the sequence of content for presentation to a user.

Variations in these and other aspects, features, elements, implementations, and embodiments of the methods, apparatus, procedures, and algorithms disclosed herein are described in further detail hereafter.

### BRIEF DESCRIPTION OF THE DRAWINGS

The description herein makes reference to the accompanying drawings wherein like reference numerals refer to like parts throughout the several views, and wherein:

FIG. 1 is a diagram of an example of a communication system for automatic content sequence generation under unit-based licensing in accordance with embodiments of this disclosure;

FIG. 2 is a flow diagram of an example of accessing content using automatic content sequence generation for digital content access in accordance with embodiments of this disclosure;

FIG. 3 is a flow diagram of an example of accessing content using automatic content sequence generation under unit-based licensing for digital content access in accordance with embodiments of this disclosure; and

FIG. 4 is a diagram of an example of a portion of a user interface for automatic content sequence generation under unit-based licensing in accordance with embodiments of this disclosure.

### DETAILED DESCRIPTION

A creator or owner of content, such as digital content, may control access to the content by licensing the content to end users. For example, licensing may include controlling the right to access content, which may include controlling the right to display, perform, distribute, or reproduce the content. Unit-based licensing may include licensing that controls access to content by allocating licensing units to a customer account, such that one or more licensing units may be redeemed or charged to access one or more events or digital content objects. For example, in some embodiments, a content provider may redeem licensing units and provide content in response to a request for access by a customer.

In some embodiments, a customer may create a sequence of content, which may be referred to herein as a station. A station may be based on a primary metric, such as a song or an artist, and may include content similar to the primary metric. In some embodiments, the content included in a station may be controlled based on one or more secondary metrics. For example, a percentage of the content included in the station authored by the author of the primary metric, relative to the content included in the station authored by an author other than the author of the primary metric, may be based on a metric. For example, a secondary metric may indicate that 50% of the content included in a station is authored by the artist of the primary metric.

The aspects, features, elements, and embodiments of methods, procedures, or algorithms disclosed herein, or any part or parts thereof, may be implemented in a computer program, software, or firmware incorporated in a non-transitory computer-readable storage medium for execution by a computer or processor, such as a special purpose computer or processor, and may be implemented as a computer program product, such as a computer program product accessible from a tangible computer-usable or computer-readable medium.

As used herein, the terminology “computer” or “device” includes any unit, or combination of units, capable of performing any method, or any portion or portions thereof, disclosed herein. Devices may further include mobile devices that may include user equipment, a wireless transmit/receive unit, a mobile station, a fixed or mobile subscriber unit, a pager, a cellular telephone, a personal digital assistant (PDA), a computer, or any other type of user device capable of operating in a mobile environment.

As used herein, the terminology “processor” includes a single processor or multiple processors, such one or more special purpose processors, one or more digital signal processors, one or more microprocessors, one or more controllers, one or more microcontrollers, one or more Application Specific Integrated Circuits (ASICs), one or more Application Specific Standard Products (ASSPs); one or more Field Programmable Gate Arrays (FPGAs) circuits, any other type or combination of integrated circuits (ICs), one or more state machines, or any combination thereof.

As used herein, the terminology “memory” includes any computer-usable or computer-readable medium or device that can, for example, tangibly contain, store, communicate, or transport any signal or information for use by or in connection with any processor. Examples of computer-readable storage mediums may include one or more read only memories, one or more random access memories, one or more registers, one or more cache memories, one or more semiconductor memory devices, one or more magnetic media, such as internal hard disks and removable disks, one or more magneto-optical media, one or more optical media such as CD-ROM disks, and digital versatile disks (DVDs), or any combination thereof.

As used herein, the terminology “example”, “embodiment”, “implementation”, “aspect”, “feature”, or “element” indicate serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “determine” and “identify”, or any variations thereof, includes selecting, ascertaining, computing, looking up, receiving, determining, establishing, obtaining, or otherwise identifying or determining in any manner whatsoever using one or more of the devices shown and described herein.

As used herein, the terminology “or” is intended to mean an inclusive “or” rather than an exclusive “or”. That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terminology “digital content” may include computer software programs, video games, music, movies, videos, or any other media that may be embodied in digital form, and which may be accessed, downloaded, input, or otherwise transferred to a computer or processor. Digital content may include digital data or digital files that may be processed by external application programs or may be executed by external software, hardware, or both. As used herein, the terminology “content” may include live content or fixed content. Fixed content may include any content that may be presented from a tangible storage medium, such as digital content. Live content may include any content that may be accessed substantially concurrently with the creation or generation of the content, such as the presentation of a movie in a movie theater, a concert, a sporting event, or any other live event.

As used herein, the terminology “event” may include any presentation, distribution, or display of content capable of concurrent, or nearly concurrent, access by multiple users. For example, an event may include a physical presentation, such a presentation at a movie theater, concert hall, park, venue, museum, or restaurant, or a virtual presentation, such as a broadcast over the Internet or a television broadcast.

As used herein, the terminology “access” or “accessing” may include presenting, downloading, executing, streaming, or otherwise interacting, or enabling interaction, with a digital content object or event. In some embodiments, digital content objects may be executed, stored, or both, at a provider location. In some embodiments, digital content objects may be stored locally on a customer network or customer device and the digital content objects may be executed or run on the customer network or device.

In some embodiments, a node based license may indicate that content is accessible by a unique device, such as a computer, a unique account, such as an account associated with an individual user, or a combination of a unique device and a unique account. In some embodiments, a network based license may indicate that content is accessible by one or more devices within a specified network. For example, a defined number of devices within the network may concurrently access the content. In some embodiments, a license, including a node based license or a network based license, may be associated with a unique content object or event, or with a suite of related content objects and events.

As used herein, the terminology “assigned units”, “price”, “licensing price” or variations thereof, may include an assigned number of licensing units that may be exchanged or redeemed to access a particular event or digital content object. As used herein, the terminology “licensed units” or “allocated units” may refer to a total number of units provided to a customer or customer group. As used herein, the terminology “checked out units”, “redeemed units”, or “exchanged units” may refer to assigned units charged to a customer for events or digital content being accessed. “Available units” may refer to a difference between licensed units and checked out units. In some embodiments, licensing units may be temporarily or permanently exchanged for access. Temporarily exchanged licensing units may be returned to the pool of available units associated with the customer upon termination or completion of content access. Returned units may be included in the available units allocated to the customer and may be redeemed for access to other events or digital content.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

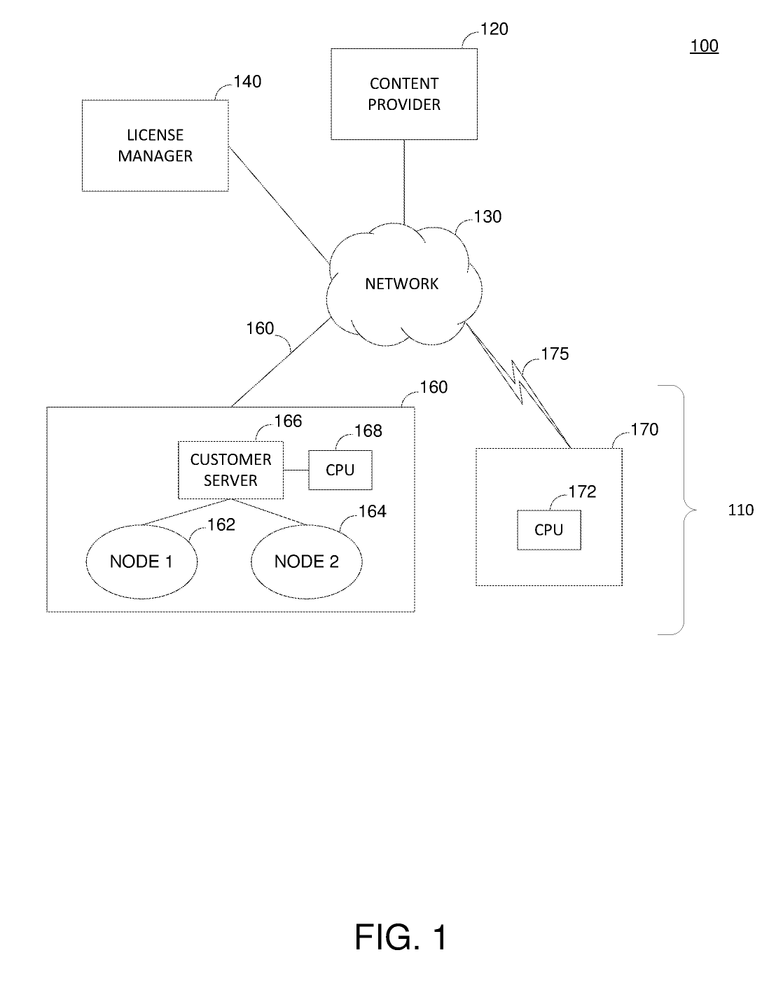

FIG. 1 is a diagram of an example of a communication system 100 for automatic content sequence generation under unit-based licensing in accordance with embodiments of this disclosure. For simplicity, the communication system 100 shown in FIG. 1 includes a customer system 110, a provider 120, a network 130, and a license manager 140; however, other elements, such as multiple networks, access points, or communication mediums may be included in a communication system for automatic content sequence generation under unit-based licensing.

In some embodiments, customer system 110 may be associated with an individual user or customer, and the user may access events or digital content using licensing units allocated to the user or to an account representing the user. In some embodiments, customer system 110 may comprise devices and networks through which a customer or user may access digital content from provider 120, or register for, or access, events. For example, as shown in FIG. 1, customer system 110 may include a customer network 160 and a customer device 170; however, any number of customer networks and customer devices may be used.

In some implementations, customer system 110 may be associated with a collection or group of customers, or members, and shared licensing units may be allocated to the group. For example, a group may include one or more families, a classroom of students, a small business, a social group, or any other organization capable of licensing events or digital content such that members of the group are capable of accessing the events or digital content.

In some embodiments, elements of the customer system 110, such as customer network 160 and customer device 170, may communicate with each other or with elements external to the customer system 110, such as the provider 120. For example, customer network 160 and customer device 170 may independently communicate through communication network 130.

In some embodiments, customer network 160 may include one or more individual nodes 162/164, a customer server 166, a host processor (CPU) 168, or any combination thereof. A node 162/164 may be a device, such as a computer, and may access digital content. For example, a node 162/164 may access digital content in response to user input. Although FIG. 1 includes a first node 162 and a second node 164 for simplicity, any number of nodes may be used. In some embodiments, a node 162/164 may be connected to a customer server 166 and may have a unique network address. In some embodiments, a node 162/164 may communicate with other nodes 162/164 within customer network 160. The customer server 166 may communicate with CPU 168. Although individual nodes 162/164 are depicted as being connected in a spoke configuration to the customer server 166, the individual nodes 162/164 may be connected in any other electronic computer network configuration. Although shown as separate units, in some embodiments, customer server 166 and CPU 168 may be combined into a single device.

In some embodiments, customer device 170 may be any device, such as a computer or mobile device, capable of accessing digital content. In some embodiments, a customer device 170 may include a processor, such as CPU 172.

In some embodiments, provider 120 may be a device or system configured to provide access to digital content to one or more licensed customers. For example, provider 120 may include an Internet Protocol (IP) network-based unit, such as a website service, that implements methods for controlling access to events or digital content. In some embodiments, provider 120 may provide customer system 110 access to digital content objects, which may be included in a suite of digital content. In some embodiments, provider 120 may be any system configured to control access to or registration for events by licensed customers. Although FIG. 1 shows the provider 120 as a single unit, the provider 120 may include any number of discrete units and any number of providers 120 may be used.

In some embodiments, the provider 120 may include an event provider (not shown separately) and may control access to or registration for one or more events. The event provider may be any system configured to receive a request to access or register for an event and output a response indicating whether access or registration is granted. In some embodiments, the request for access may include a request to register for the event, which may include receiving registration information. In some embodiments, the event provider may be the provider 120. In some embodiments, event provider may be separate from provider 120. Although shown as a single unit in FIG. 1, in some embodiments, the provider 120 may include a content provider as a first unit and the event provider as a second unit. For example, the content provider and the event provider may be independent units within a single physical device, or may be independent physical devices.

In some implementations, unit-based licensing for events and digital content may include communication between the customer system 110 and the provider 120 via the communication network 130. The communication network 130 may be a local area network (LAN), wide area network (WAN), virtual private network (VPN), a mobile or cellular telephone network, the Internet, or any other electronic communication medium. Although not explicitly shown in FIG. 1, each of the customer system 110, provider 120, and license manager 140 may communicate with communication network 130 through one or more Internet service providers (ISPs). In some embodiments, the customer network 160, the customer device 170, or both, may communicate with the network 130 via a wired connection 165 a wireless connection 175, or a combination of one or more wired or wireless connections.

In some embodiments, a license manager (LM) 140 may be included in the communication system 100. License manager 140 may control the access to events, digital content, or both, provided by provider 120. Although shown as a separate unit, in some embodiments, license manager 140 may be incorporated with provider 120, customer system 110, or both. In some embodiments, the license manager 140 may monitor content access for the customer system 110. For example, the license manager 140 may detect the termination or conclusion of access to content.

In some embodiments, license manager 140 may generate and maintain a log. The log may include a record of a number of available units that may be used by the customer system 110 at any given time. In some embodiments, the license manager 140 may update the log for each change of the available units for customer system 110. For example, the log may be updated to indicate a change in the available units in response to the accessing of events or digital content from provider 120, the termination of the access of events or digital content, or a change in pricing of events or digital content being accessed by the customer. In some embodiments, the log may be a file, or database, stored in a memory in communication with provider 120 or license manager 140.

Although not shown in FIG. 1, in some embodiments, communication system 100 may include a registration unit. In some embodiments, a registration unit may be a device, such as a computer. For example, the registration unit may be a kiosk physically located at an event location. In some embodiments, the registration unit may be configured to receive registration information. For example, the registration unit may include a user interface device, such as a keyboard or touchscreen, and may receive user input indicating registration information via the user input device. In some embodiments, the registration unit may communicate with a user device, such as customer device 170.

Although not shown separately in FIG. 1, in some embodiments, a device, such as customer device 170, may access content other than content licensed under unit-based licensing. For example, automatic content sequence generation may omit unit-based licensing.

In some embodiments, automatic content sequence generation under unit-based licensing may include controlling access to content in response to a request to access the event or digital content from a customer system.

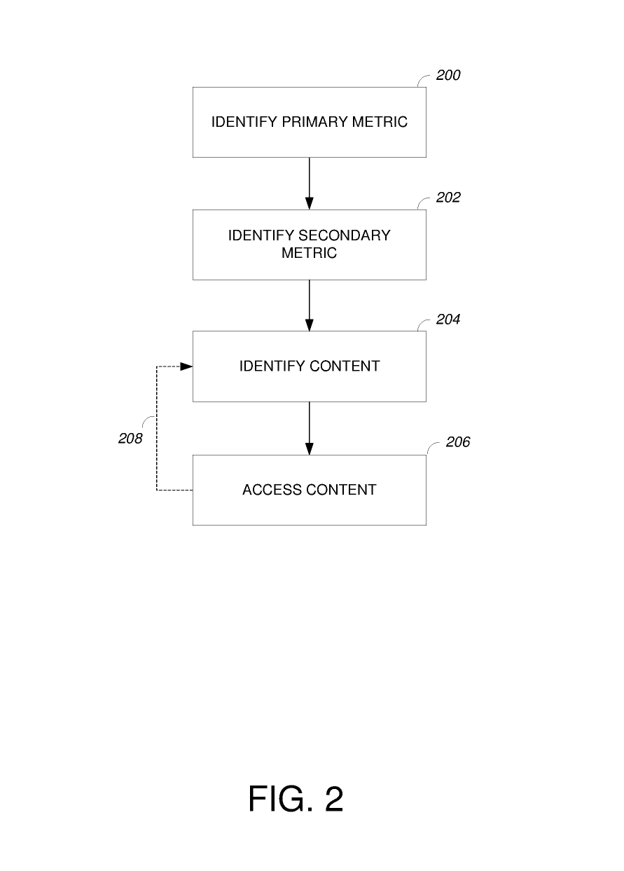

FIG. 2 is a flow diagram of an example of automatic content sequence generation in accordance with embodiments of this disclosure. In some embodiments, automatic content sequence generation may be implemented in a device, such as the customer device 170 shown in FIG. 1, which may communicate via a communication system, such as the Internet, or any other wired or wireless computer communication system or network.

In some embodiments, accessing content using automatic content sequence generation may include identifying a primary metric at 200, identifying a secondary metric at 202, identifying content at 204, accessing the content at 206/208, or a combination thereof.

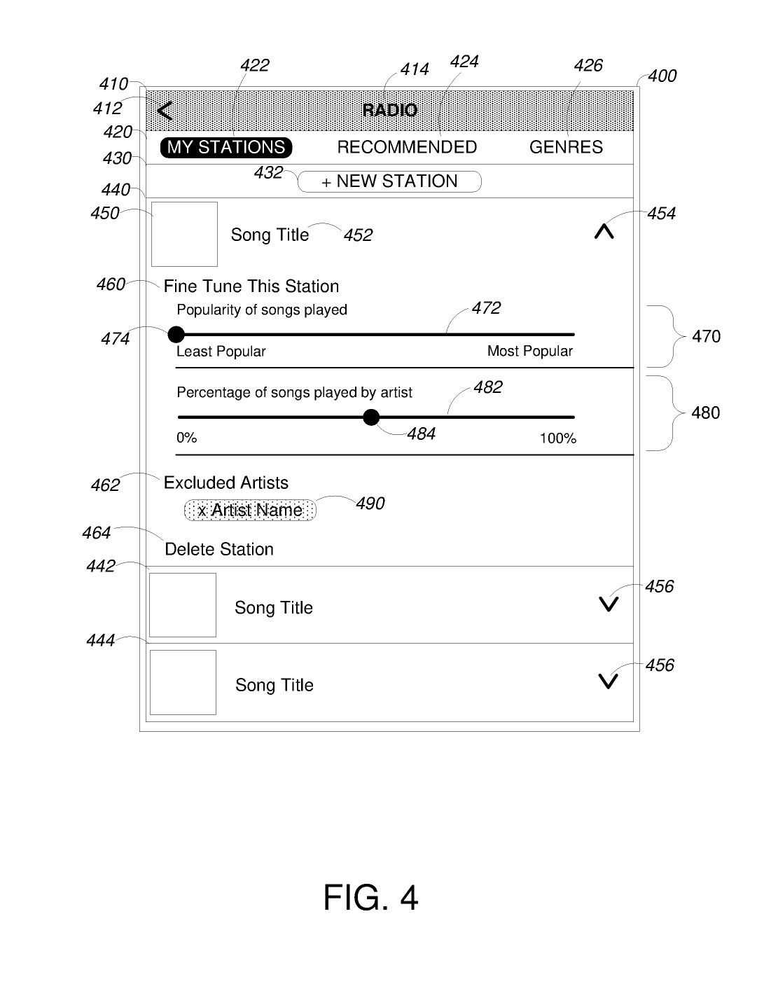

In some embodiments, a primary metric may be identified at 200. Identifying a primary metric may include identifying content. For example, the primary metric may be a song, an author or artist, an album, or any other content. In some embodiments, identifying the primary metric may be performed in response to input, such as user input. For example, identifying the primary metric may include identifying a defined primary metric from an existing station in response to input selecting the station, such as input selecting the album art 450 or title 452 shown in FIG. 4. In another example, identifying the primary metric may include generating a new station in response to input, such as user input selecting the new station control 432 shown in FIG. 4, and may include receiving input, such as user input, include text identifying the primary metric, selecting the primary metric from a list of content, or a combination thereof.

In some embodiments, one or more secondary metrics may be identified at 202. In some embodiments, identifying the secondary metrics may include identifying one or more automatically generated metrics, one or more manually generated metrics, or a combination thereof. For example, generating a new station in response to input, such as user input selecting the new station control 432 shown in FIG. 4, may include automatically generating one or more secondary metrics, which may include a popularity metric, a percent primary metric, or any other metric, or combination of metrics. A popularity metric may indicate a minimal popularity rating for including content in the station and may correspond with a user interface control, such as the popularity control 470 shown in FIG. 4. A percent primary metric may indicate a percentage of the content included in the station authored by an author of the primary content and may correspond with a user interface control, such as the percent primary control 480 shown in FIG. 4.

In some embodiments, content may be identified at 204. Identifying content at 200 may include identifying any type of content, such as an audio recording, an electronic text publication, a video, or a combination thereof, based on the primary metric, the secondary metrics, or a combination thereof. For example, the primary metric may be a song by an artist, and identifying the content at 204 may include identifying content based on a similarity between the identified content and the song, or a similarity between the identified content and the artist. In some embodiments, the identified content may include content authored by the artist, content authored by another artist, or a combination thereof. In some embodiments, the similarity for the identified content may be above a minimum similarity threshold. In some embodiments, the similarity for the identified content may be above an authorship threshold, which may indicate that an author of the identified content is an author indicated by the primary metric, or an author of a content object indicated by the primary metric. In some embodiments, identifying the content at 204 may include identifying available content and identifying content from the available content based on the primary metric. For example, the available content may include content available for access by a user or customer.

In some embodiments, identifying the content at 204 may include identifying the content based on the secondary metrics. For example, the secondary metrics may include an indication of one or more excluded songs or artists, which may correspond with a user interface control, such as the excluded artists control 462 shown in FIG. 4. For example, the station may be associated with an excluded artist metric, such as the excluded artist 490 shown in FIG. 4, and identifying the content at 204 may include excluded content authored by the excluded artist.

In another example, identifying the content at 204 may include evaluating a popularity metric, which may indicate a minimal popularity rating for including content in the station and may correspond with a user interface control, such as the popularity control 470 shown in FIG. 4. For example, the popularity metric may have a minimal value, which may indicate that any content that has a popularity greater than the minimal available popularity, which may include any available content, may be included in the station. In another example, the popularity metric may have a maximal value, which may indicate that the most popular content may be included in the station and less popular content may be omitted from the station.

In another example, identifying the content at 204 may include evaluating a percent primary metric, which may indicate a percentage of the content that may be included in the station that is authored by an author of the primary content and may correspond with a user interface control, such as the percent primary control 480 shown in FIG. 4. For example, the percent primary metric may have a value of 0%, and identifying the content at 204 may include omitting any content authored by the author of the primary metric. In another example, the percent primary metric may have a value of 100%, and identifying the content at 204 may include omitting any content authored by an artist other than the author of the primary metric. In another example, the percent primary metric may have a value of 50%, and identifying the content at 204 may include identifying a plurality of songs such that half the songs are authored by the author of the primary metric and the other half of the songs are authored by artists other than the author of the primary metric. In some embodiments, the plurality of songs may be randomly ordered or may be ordered such that a song authored by an artist other than the author of the primary metric is preceded and followed by a song authored by the author of the primary metric, and each song authored by the author of the primary metric is preceded and followed by a song authored by an artist other than the author of the primary metric.

In some embodiments, identifying the content at 204 may be implemented in a combination of devices. For example, identifying the content at 204 may be implemented in part in a user device, such as the customer device 170 shown in FIG. 1, and in part in an external device, such as a network server, which may be a server of the content provider 120. In some embodiments, the external device may generate a content sequence, or a portion thereof, may communicate an indication of the content sequence, or a portion thereof, to the customer device, and the customer device may identify the content in response to the communication.

In some embodiments, the content may be accessed at 206. For example, the content may be stored on a computer readable storage medium included in or directly accessible by the customer device, such as a memory, a disk drive, a network drive, or any other locally accessible computer readable storage medium. In some embodiments, the content may be stored on an external device, such as a network server, and accessing the content at 206 may include receiving the content at the customer device from the external device, which may include communicating via a network, such as the Internet. In some embodiments, receiving the content at the customer device may include storing the content, or a portion thereof, at the customer device.

In some embodiments, accessing content using automatic content sequence generation may include traversing the automatically generated content sequence as indicated by the broken line 208 in FIG. 2. For example, identifying the content at 204 may include identifying a first digital content object from the automatically generated content sequence and accessing the content at 206 may include accessing the first digital content object, and traversing the automatically generated content sequence may include identifying a second digital content object from the automatically generated content sequence at 204 and accessing the second digital content object at 206. In some embodiments, traversing the automatically generated content sequence may be performed in response to an event, such as in response to the end of a digital content object, or in response to input, such as user input selecting a next, or previous, digital content object.

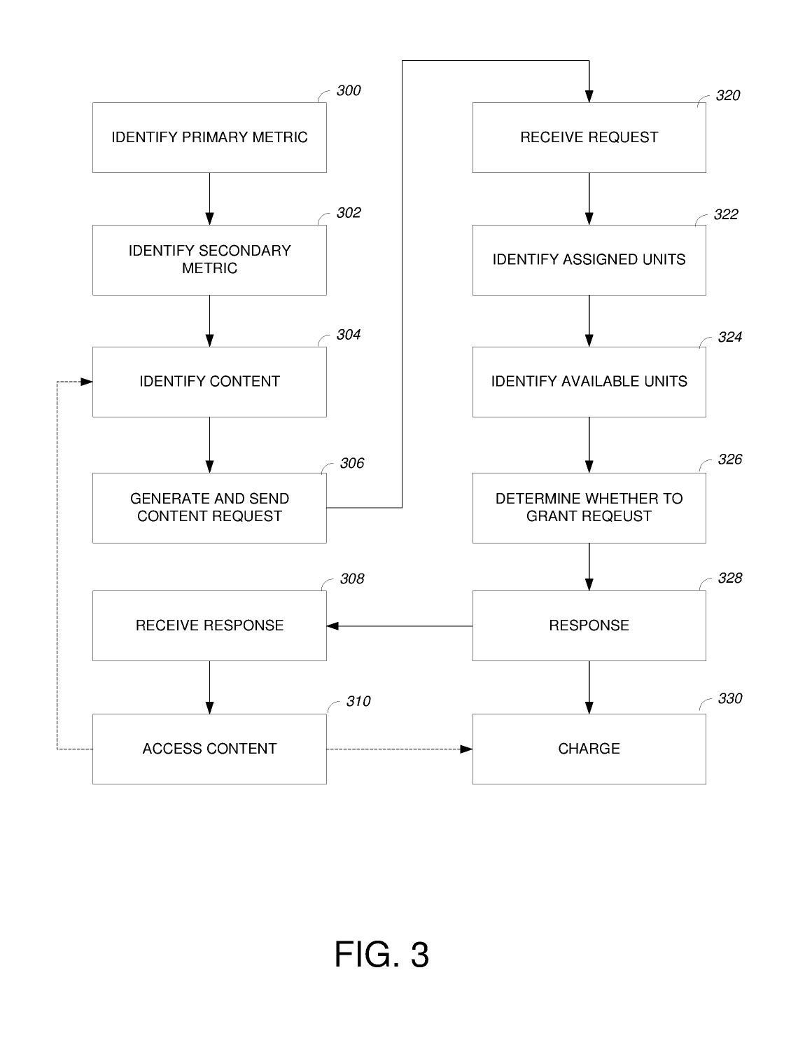

FIG. 3 is a flow diagram of an example of automatic content sequence generation under unit-based licensing in accordance with embodiments of this disclosure. In some embodiments, automatic content sequence generation under unit-based licensing may be implemented in a communication system, such as the communication system 100 shown in FIG. 1.

In some embodiments, accessing content in automatic content sequence generation under unit-based licensing may include temporarily or permanently exchanging licensing units for access to content. For example, unit-based licensing may include licensing that controls access to content by allocating licensing units to a customer account, such that one or more licensing units may be redeemed or charged to access one or more events or digital content objects. In some embodiments, a customer account may be associated with an individual user or customer, or with a group of users associated with a customer account, and each user may access content using licensing units allocated to the user or to the customer account representing the user.

In some embodiments, automatic content sequence generation under unit-based licensing may include identifying a primary metric at 300, identifying a secondary metric at 302, identifying content at 304, generating and sending a content request at 316, receiving a response to the content request at 308, accessing the content at 310, receiving the content request at 320, identifying assigned units at 322, identifying available units at 324, determining whether to grant the request at 326, responding to the request at 328, charging for the content at 330, or a combination thereof.

In some embodiments, a primary metric may be identified at 300. Identifying a primary metric may include identifying content. For example, the primary metric may be a song, an author or artist, an album, or any other content. In some embodiments, identifying the primary metric may be performed in response to input, such as user input. For example, identifying the primary metric may include identifying a defined primary metric from an existing station in response to input selecting the station, such as input selecting the album art 450 or title 452 shown in FIG. 4. In another example, identifying the primary metric may include generating a new station in response to input, such as user input selecting the new station control 432 shown in FIG. 4, and may include receiving input, such as user input, include text identifying the primary metric, selecting the primary metric from a list of content, or a combination thereof.

In some embodiments, one or more secondary metrics may be identified at 302. In some embodiments, identifying the secondary metrics may include identifying one or more automatically generated metrics, one or more manually generated metrics, or a combination thereof. For example, generating a new station in response to input, such as user input selecting the new station control 432 shown in FIG. 4, may include automatically generating one or more secondary metrics, which may include a popularity metric, a percent primary metric, or any other metric, or combination of metrics. A popularity metric may indicate a minimal popularity rating for including content in the station and may correspond with a user interface control, such as the popularity control 470 shown in FIG. 4. A percent primary metric may indicate a percentage of the content included in the station authored by an author of the primary content and may correspond with a user interface control, such as the percent primary control 480 shown in FIG. 4.

In some embodiments, content may be identified at 304. Identifying content at 300 may include identifying any type of content, such as an audio recording, an electronic text publication, a video, or a combination thereof, based on the primary metric, the secondary metrics, or a combination thereof. For example, the primary metric may be a song by an artist, and identifying the content at 304 may include identifying content based on a similarity between the identified content and the song, or a similarity between the identified content and the artist. In some embodiments, the identified content may include content authored by the artist, content authored by another artist, or a combination thereof.

In some embodiments, identifying the content at 304 may include identifying the content based on the secondary metrics. For example, the secondary metrics may include an indication of one or more excluded songs or artists, which may correspond with a user interface control, such as the excluded artists control 462 shown in FIG. 4. For example, the station may be associated with an excluded artist metric, such as the excluded artist 490 shown in FIG. 4, and identifying the content at 304 may include excluded content authored by the excluded artist.

In another example, identifying the content at 304 may include evaluating a popularity metric, which may indicate a minimal popularity rating for including content in the station and may correspond with a user interface control, such as the popularity control 470 shown in FIG. 4. For example, the popularity metric may have a minimal value, which may indicate that any content that has a popularity greater than the minimal available popularity, which may include any available content, may be included in the station. In another example, the popularity metric may have a maximal value, which may indicate that the most popular content may be included in the station and less popular content may be omitted from the station.

In another example, identifying the content at 304 may include evaluating a percent primary metric, which may indicate a percentage of the content that may be included in the station that is authored by an author of the primary content and may correspond with a user interface control, such as the percent primary control 480 shown in FIG. 4. For example, the percent primary metric may have a value of 0%, and identifying the content at 304 may include omitting any content authored by the author of the primary metric. In another example, the percent primary metric may have a value of 100%, and identifying the content at 304 may include omitting any content authored by an artist other than the author of the primary metric. In another example, the percent primary metric may have a value of 50%, and identifying the content at 304 may include identifying a plurality of songs such that half the songs are authored by the author of the primary metric and the other half of the songs are authored by artists other than the author of the primary metric. In some embodiments, the plurality of songs may be randomly ordered or may be ordered such that a song authored by an artist other than the author of the primary metric is preceded and followed by a song authored by the author of the primary metric, and each song authored by the author of the primary metric is preceded and followed by a song authored by an artist other than the author of the primary metric.

In some embodiments, identifying the content at 304 may be implemented in a combination of devices. For example, identifying the content at 304 may be implemented in part in a device, such as the customer device 170 shown in FIG. 1, and in part in an external device, such as a network server, which may be a server of the content provider 120. In some embodiments, the external device may generate a content sequence, or a portion thereof, may communicate an indication of the content sequence, or a portion thereof, to the customer device, and the customer device may identify the content in response to the communication.

In some embodiments, a request to access content may be generated and sent at 306. For example, the content request may be generated in response to input, such as user input selecting the station. The content request may be sent to unit-based licensing platform control device, such as the license manager 140 or the content provider 120 shown in FIG. 1.

In some embodiments, the request to access content may be received at 320. For example, a provider, such as the provider 120 shown in FIG. 1, may receive the request from a customer, such as the customer system 110 shown in FIG. 1. In some embodiments, the request may indicate a selected digital content object, such as the content identified at 304. In some embodiments, the request to access content may include information identifying a customer, a customer account associated with the customer, or both.

In some embodiments, assigned license units for the selected content may be identified at 322. In some embodiments, the number of assigned units for the content may remain constant or may vary over time. In some embodiments, a license manager, such as the license manager 140 shown in FIG. 1, may identify the assigned license units for the selected content. In some embodiments, the license manager may be independent of the provider, and the license manager may receive the request from the customer system via the network or via the provider. In some embodiments, determining the assigned license units for the selected content may be based on the customer, a customer account associated with the customer, or a combination thereof. In some embodiments, the request received at 320 may indicate that the request is associated with a station, identifying the license units for the selected content may be omitted, and a number of assigned license units for accessing the station may be identified at 322.

In some embodiments, a number or cardinality of available units associated with the customer, or a customer account associated with the receiving user, may be determined at 324. In some embodiments, the available units may indicate a number of licensing units that may be used by the customer system at a given time, such as at the time the request is received. For example, although not shown in FIG. 3, one or more licensing units may be allocated or licensed to the customer system, one or more of the allocated units may be temporarily or permanently exchanged or checked out for access to content, and the number of available units may indicate the difference between the number of allocated units and the number of checked out units.

In some embodiments, whether to grant access may be determined at 326. For example, determining whether to grant access at 326 may be based on the count of available units identified at 324, the number of assigned units identified at 322, or a combination thereof. For example, determining whether to grant access at 340 may include determining whether the count of available units is equal to or greater than the number of assigned units.

In some embodiments, determining whether to grant access at 326 may include determining the number of available licensing units allocated to the customer system to charge against the customer system for access to the selected content. In some embodiments, the provider or the licensing manager may determine the number of checked out units currently charged against the customer system, and may determine a number of licensing units to charge against the customer system based on a difference between the number of assigned units and the number of currently checked out units for the customer system. For example, the number of currently checked out units for the customer system may be greater than the number of assigned units, the request may be granted and the number of units to charge against the customer system may be zero. In another example, the number of currently checked out units for the customer system may be less than the number of assigned units, the request may be granted, and the number of units to charge against the customer system may be equal to the difference between the number of assigned units and the number of currently checked out units.

In some embodiments, a response may be output at 328. For example, the provider or licensing manager may generate a response indicating that the request for access is granted or denied and may transmit the response to the customer system. In some embodiments, the request for access may be denied. For example, the number of available units associated with the customer may be less than the number of assigned units and the request may be denied. In some embodiments, the provider may reject the request and may prevent the customer system from accessing the content. In some embodiments, the request for access may be granted. For example, the number of available units associated with the customer may be equal to or greater than the number of assigned units and the request may be granted.

In some embodiments, a number of available licensing units allocated to the customer system may be charged to the customer system at 330. In some embodiments, the customer system may be charged in response to granting the request for access. In some embodiments, the customer system may be charged in response to receiving the content at the customer system from the provider. In some embodiments, the customer system may be charged in response to accessing the content by one or more customer devices or nodes in the customer system at 310.

In some embodiments, charging the customer system may include recording the number of licensing units charged, updating the number available units associated with the customer system, or both. In some embodiments, the license manager or provider may record any change in charged units or available units in a log. In some embodiments, the number of available units for the customer system may be decreased in an amount equal to the number of assigned units for the content indicated in the request.

In some embodiments, charging the customer system at 330 may include receiving information indicating that a customer device or node is accessing the requested content (shown using a broken line in FIG. 3). For example, the content may be accessed from the provider in response to receiving the response generated at 308. In some embodiments, the customer system may receive at 308 a response to the request sent at 306, which may be the response generated at 328, and may access the content at 310.

Although not shown separately in FIG. 3, in some embodiments, one or more elements of accessing content in automatic content sequence generation under unit-based licensing may be omitted or combined. For example, generating and sending a content request at 316, receiving a response to the content request at 308, receiving the content request at 320, identifying assigned units at 322, identifying available units at 324, determining whether to grant the request at 326, responding to the request at 328, and charging for the content at 330 may be omitted. In another example, a content request indicating a station may be generated and sent at 316, a number of assigned units for accessing the station may be identified at 322, and the number of assigned units for accessing the station may be charged at 330 in response to beginning access to the station, and accessing other content included in the station may omit generating and sending a content request at 316, receiving a response to the content request at 308, receiving the content request at 320, identifying assigned units at 322, identifying available units at 324, determining whether to grant the request at 326, responding to the request at 328, and charging for the content at 330, for a defined period or until a defined event is detected. For example, in response to an indication, such as user input, indicating that the customer has ceased accessing the station, the number of assigned units for accessing the station may be removed from the number of licensing units charged to the customer and may be added to the number of available units for the customer.

FIG. 4 is a diagram of an example of a portion of a user interface 400 for automatic content sequence generation under unit-based licensing in accordance with embodiments of this disclosure. In some embodiments, a user interface 400, or a portion thereof, for automatic content sequence generation under unit-based licensing may include a header portion 410, a primary control portion 420, a secondary control portion 430, one or more station portions 440/442/444, or a combination thereof.

Automatic content sequence generation under unit-based licensing may include automatically identifying and presenting content in a sequence based on one or more input metrics identified based on input, such as user input. For example, the metrics may include a first song, and automatic content sequence generation under unit-based licensing may automatically include identifying and presenting a second song based on the first song. For simplicity, a set of metrics for automatic content sequence generation under unit-based licensing may be referred to herein as a station, a radio station, or radio; however, references to radio, a radio station, or a station herein are used for simplicity only and do not refer to a traditional broadcast radio station. Although described with reference to music, any content type may be used with the methods and apparatus described herein. For example, set of metrics may be used to automatically generate a sequence of videos or a sequence of books.

In some embodiments, the header portion 410 may include one or more control elements 412, such as a back control as shown, one or more information elements 414, which may indicate a name of the portion of the user interface as shown, or a combination thereof.

In some embodiments, the primary control portion 420 may include one or more primary context controls 422/424/426. In some embodiments, a current context 422 may be visually differentiated from other contexts 424/426.

In some embodiments, the secondary control portion 430 may include one or more secondary control elements 432, such as the new station control element shown. For example, a new station portion (not shown) may be included in the user interface 400 in response to input, such as user input, selecting the new station control 432. In some embodiments, creating a new station may include identifying a primary metric, such as a source song.

In some embodiments, each station portion 440/442/444 may correspond with a respective station and may include a representation of a set of metrics for automatic content sequence generation under unit-based licensing. In some embodiments, the set of metrics may include a primary metric, such as a source song, and one or more secondary metrics, such as excluded artists, a popularity metric, and a source artist frequency metric.

In some embodiments, a station portion 440/442/444 may include a representation of the station 450, a name of the station 452, one or more controls 454/456, or a combination thereof. For example, the primary metric may be a source song, the representation of station 450 may include album or track art for the source song, and the name of the station 452 may include a title of the source song. In some embodiments, the station portion 440/442/444 for a station may be expanded to show one or more of the secondary metrics for the station, as shown for the first station from the top 440, or may be contracted to hide the secondary metrics, as shown for the bottom two stations 442/444. For example, an expanded station, such as the first station from the top 440, may be contracted in response to input selecting a contract control 454 for the station, and a contracted station, such as the bottom two stations 442/444, may be expanded in response to input selecting the an expand control 456 for the station.

In some embodiments, a station portion 440/442/444 may include one or more controls 460/462/464 for the station, such as a detail control portion 460, an exclusions control portion 462, and a delete station control 464. In some embodiments, one or more of the controls 460/462/464 may correspond with one or more of the secondary metrics 470/480. In some embodiments, a secondary metric control 470/480 may include one or more control details, such as a description of the metric, a representation of a continuum for the metric 472/482, a representation of a current value of the metric 474/484, a description of a minimum value of the metric, a description of a maximum value of the metric, or a combination thereof. In some embodiments, an exclusions portion 462 may indicate one more artists 490 excluded from the station. In some embodiments, a station may be deleted in response to input selecting a delete control 464.

In an example, the secondary metric control portion 470 at the top may represent a popularity metric for the station, and may include a description indicating that the metric represents a measure of the popularity of songs included in the station, a representation of a continuum for the metric 472, a representation of a current value of the metric 474, a description of a minimum value of the metric, a description of a maximum value of the metric, or a combination thereof. In some embodiments, the current value of the metric may be updated in response to input, such as input sliding the representation of a current value of the metric 474 along the representation of the continuum of the metric 472.

In another example, the secondary metric control portion 480 at the bottom may represent a primary artist frequency metric for the station, and may include a description indicating that the metric represents a measure of frequency with which content from the author or artist of the primary metric is included in the station, a representation of a continuum for the metric 482, a representation of a current value of the metric 484, a description of a minimum value of the metric, a description of a maximum value of the metric, or a combination thereof. In some embodiments, the current value of the metric may be updated in response to input, such as input sliding the representation of a current value of the metric 484 along the representation of the continuum of the metric 482. For example, in FIG. 4, the representation of the current value of the primary artist frequency metric 484 is shown as halfway between the minimum value, 0%, and the maximum value, 100%, which may correspond with 50%.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A method comprising:
receiving input indicating a request to access a sequence of content;
identifying a primary metric associated with the sequence of content;
identifying a secondary metric associated with the sequence of content;
automatically identifying a first plurality of content objects;
automatically identifying a second plurality of content objects from the first plurality of content objects, such that each content object from the second plurality of content objects has a determined similarity with the primary metric above a minimum similarity threshold;
automatically identifying, by a processor in response to instructions stored on a non-transient computer readable medium, a third plurality of content objects from the second plurality of content objects, wherein automatically identifying the third plurality of content objects includes:
on a condition that the secondary metric indicates a percentage associated with the primary metric, automatically identifying the third plurality of content objects such that a percentage of content objects included in the third plurality of content objects for which the determined similarity is above an authorship threshold corresponds with the percentage associated with the primary metric, and a percentage of content objects included in the third plurality of content objects for which the determined similarity is within the authorship threshold corresponds with a difference between 100 percent and the percentage associated with the primary metric; and
automatically identifying the sequence of content based on the third plurality of content objects;
automatically identifying a sequentially first content object from the sequence of content; and
outputting the sequentially first content object for presentation to a user.

2. The method of claim 1, wherein identifying the primary metric includes:
identifying a song, an author, an artist, an album, a book, a magazine, or a video.

3. The method of claim 1, wherein automatically identifying the first plurality of content objects includes:
automatically identifying content objects available for access by the user; and
including the content objects available for access by the user in the first plurality of content objects.

4. The method of claim 1, wherein automatically identifying the second plurality of content objects includes:
identifying a first author based on the primary metric; and
automatically identifying the second plurality of content objects such that a second author of at least one content object from the second plurality of content objects differs from the first author.

5. The method of claim 1, wherein:
on a condition that the primary metric indicates an author, identifying the author as a primary author;
on a condition that the primary metric indicates a content object, identifying an author of the content object as the primary author; and
automatically identifying the third plurality of content objects includes, automatically identifying the third plurality of content objects such that the primary author is an author of the content objects for which the determined similarity is above the authorship threshold, and another author is an author of the content objects for which the determined similarity is within the authorship threshold.

6. The method of claim 1, identifying the secondary metric includes:
identifying a plurality of secondary metrics, wherein the plurality of secondary metrics includes the secondary metric.

7. The method of claim 6, wherein a second secondary metric from the plurality of secondary metrics indicates an excluded artist, and wherein automatically identifying the third plurality of content objects includes omitting content objects authored by the excluded artist from the third plurality of content objects.

8. The method of claim 6, wherein a second secondary metric from the plurality of secondary metrics indicates a minimal popularity, and wherein automatically identifying the third plurality of content objects includes omitting content objects having a determined popularity that is less than the minimal popularity from the third plurality of content objects.

9. The method of claim 1, further comprising:
identifying a sequentially second content object from the sequence of content; and
outputting the sequentially second content object for presentation to the user.

10. The method of claim 1, further comprising:
on a condition that a cardinality of assigned units for the sequentially first content object exceeds a cardinality of available units for the user, omitting outputting the sequentially first content object for presentation to the user.

11. A method comprising:
receiving input indicating a request to access a sequence of content;
identifying a primary metric associated with the sequence of content;
identifying secondary metrics associated with the sequence of content, wherein the secondary metrics include an authorship metric and a popularity metric;
automatically identifying a plurality of similar content objects from a plurality of available content objects, such that each content object from the plurality of similar content objects has a determined similarity with the primary metric above a minimum similarity threshold;
automatically identifying, by a processor in response to instructions stored on a non-transient computer readable medium, a plurality of filtered content objects from the plurality of similar content objects, wherein automatically identifying the plurality of filtered content objects includes:
automatically identifying the plurality of filtered content objects such that a percentage of content objects included in the plurality of filtered content objects for which the determined similarity is above an authorship threshold corresponds with a percentage indicated by the authorship metric, and a percentage of content objects included in the plurality of filtered content objects for which the determined similarity is within the authorship threshold corresponds with a difference between 100 percent and the percentage indicated by the authorship metric;
omitting content objects having a determined popularity that is less than a minimal popularity from the plurality of filtered content objects, wherein popularity metric indicates the minimal popularity; and
automatically identifying the sequence of content based on the plurality of filtered content objects;
automatically identifying a sequentially first content object from the sequence of content; and
outputting the sequentially first content object for presentation to a user.

12. The method of claim 11, wherein identifying the primary metric includes:
identifying a song, an author, an artist, an album, a book, a magazine, or a video.

13. The method of claim 11, further comprising:
automatically identifying content objects available for access by the user; and
including the content objects available for access by the user in the plurality of available content objects.

14. The method of claim 11, wherein automatically identifying the plurality of similar content objects includes:
identifying a first author based on the primary metric; and
automatically identifying the plurality of similar content objects such that an author of a first similar content object from the plurality of similar content objects is the first author, and an author of a second similar content object from the plurality of similar content objects differs from the first author.

15. The method of claim 11, wherein the secondary metrics include an indication of an excluded artist, and wherein automatically identifying the plurality of filtered content objects includes omitting content objects authored by the excluded artist from the plurality of filtered content objects.

16. The method of claim 11, further comprising:
on a condition that a cardinality of assigned units for the sequentially first content object exceeds a cardinality of available units for the user, omitting outputting the sequentially first content object for presentation to the user.

17. A method comprising:
receiving input indicating a request to access a sequence of content, wherein the sequence of content is associated with a primary author and an authorship metric;
automatically identifying, by a processor in response to instructions stored on a non-transient computer readable medium, similar content, such that a similarity between the similar content and the primary author is above a minimum similarity threshold, and such that a percentage of the similar content for which the similarity is above an authorship threshold corresponds with a percentage indicated by the authorship metric;
automatically identifying the sequence of content based on the plurality of filtered content objects; and
outputting sequentially first content from the sequence of content for presentation to a user.

18. The method of claim 17, wherein identifying the primary metric includes:
identifying a song, an author, an artist, an album, a book, a magazine, or a video.

19. The method of claim 17, wherein:
on a condition that the sequence of content is associated with a popularity metric, omitting content having a determined popularity that is less than a minimal popularity indicated by the minimal popularity from the similar content; and
on a condition that the sequence of content is associated with an excluded artist, omitting content authored by the excluded artist from the similar content.

20. The method of claim 17, further comprising:
on a condition that a cardinality of assigned units for the sequentially first content exceeds a cardinality of available units for the user, omitting outputting the sequentially first content for presentation to the user.
